(19) United States
(12) Patent Application Publication
(10) Pub. No.: US 2008/0147793 A1
(43) Pub. Date: Jun. 19, 2008

(54) Method And System For Coordinating A Synchronous Activity

(76) Inventors: Munindar P. Singh, Cary, NC (US); Mona Singh, Cary, NC (US)

Correspondence Address: SCENERA RESEARCH, LLC, 111 CORNING RD., SUITE 220, CARY, NC, 27511, US

(21) Appl. No.: 11/554,842

(22) Filed: Oct. 31, 2006

(51) Int. Cl. G06F 15/16

(52) U.S. Cl. 709/204

(57) ABSTRACT

A method for coordinating a synchronous activity includes receiving an instruction from a first principal to send a tag request to a second principal to participate in an activity and sending the tag request to the second principal. After the tag request is received, it is determined whether the second principal is available to participate in the activity. When the second principal is available, a response is sent indicating that the second principal is available to participate in the activity and the first principal is notified that the second principal is available to participate in the activity after the response is received and it is determined that the first principal is available to receive the notification.

### COPYRIGHT NOTICE

A portion of the disclosure of this patent document contains material which is subject to copyright protection. The copyright owner has no objection to the facsimile reproduction by anyone of the Patent and Trademark Office patent file or records, but otherwise reserves all copyright rights whatsoever.

### BACKGROUND

Electronic communication devices, such as smart phones and mobile phones, offer a variety of convenient services to their users that traditional analog telephones are not equipped to provide. For example, many communication devices include calendaring and/or “to-do list” applications that allow the user to schedule appointments and to enter tasks directly into the device via an input/output component such as a keypad or touchpad. Some communication devices can be configured to provide a reminder, e.g., an alarm, when the time for an appointment or task is near. Moreover, many electronic communication devices are network-enabled, that is, they are configured to access a network, such as the Internet, so that electronic data can be sent and received to and from other similarly enabled communication devices via the network.

Although electronic communication devices are by far more versatile then their analog predecessors, such devices still suffer from the inefficiencies and frustrations of attempting to arrange an activity, such as a phone call, with another principal or user. For example, typically when a first principal calls a second principal and the second principal does not or cannot accept the call, e.g., because the second principal is on another call or otherwise unavailable, the first principal can leave a voice message on the second principal's voice mailbox asking the second principal to return the call. When the second principal returns the call and the first principal does not or cannot accept the call, the second principal can leave a voice message on the first principal's voice mailbox. This sequence, typically referred to as “phone tag,” can repeat several times and is highly inefficient and time consuming.

To address this problem, some applications can schedule in advance the activity between the first and second principals. For example, some applications can compare the calendars of the first and second principals to determine the availability of each principal and to schedule a time during which the activity can occur. Nevertheless, this can be inefficient when the call is of a very short duration or when the call is urgent and the scheduled time is too late. Moreover, because the scheduling process is based on a static source, i.e., the electronic calendar, opportunities to engage in an urgent activity can be lost because the scheduling application cannot take into consideration the actual availability of the principal at any given moment. For example, if a meeting is canceled or if the meeting ends early, the scheduling application is not aware of the principal's unexpected availability and so an opportunity to engage in the urgent activity can be lost.

In addition to the issues discussed above, scheduling activities based on calendars is problematic because principals are required to expose information about their schedules to others, which for security reasons, would be detrimental across different organizations. Moreover, some “thin” communication devices, such as mobile phones, are not equipped with scheduling applications via which they can schedule phone calls.

### SUMMARY

Accordingly, a method and system for coordinating a synchronous activity between a first and a second principal are described. According to one exemplary embodiment, the method includes receiving an instruction from a first principal to send a tag request to a second principal to participate in an activity and sending the tag request to the second principal. The method further includes determining whether the second principal is available to participate in the activity after the tag request is received and sending a response indicating the second principal is available to participate in the activity. The first principal is notified that the second principal is available to participate in the activity after the response is received and it is determined that the first principal is available to receive the notification.

In another exemplary embodiment, a system for coordinating a synchronous activity includes first and second communication devices associated with respective first and second principals communicatively coupled via a network. The system also includes a first assistant component associated with the first principal for receiving an instruction from the first communication device to send a tag request to the second principal to participate in an activity and a second assistant component associated with the second principal configured to receive the tag request from the first assistant component, to determine whether the second principal is available to participate in the activity via the second communication device, and to send a response to the first assistant component when the second assistant component determines that the second principal is available to participate in the activity. In one embodiment, the first assistant component is further configured to notify the first principal that the second principal is available to participate in the activity after the first assistant component receives the response from the second assistant component and determines that the first principal is available to receive the notification via the first communication device.

### BRIEF DESCRIPTION OF THE DRAWINGS

The accompanying drawings provide visual representations which will be used to more fully describe the representative embodiments disclosed here and can be used by those skilled in the art to better understand the representative embodiments and their inherent advantages. In these drawings, like reference numerals identify corresponding elements, and:

FIG. 1 is a block diagram illustrating an exemplary system for coordinating an activity according to an exemplary embodiment;

FIG. 2 is a block diagram illustrating an exemplary data store used by the exemplary system in FIG. 1 according to one embodiment;

FIG. 3-FIG. 6 is a flow diagram illustrating an exemplary process for coordinating a synchronous activity according to one embodiment.

### DETAILED DESCRIPTION

Various aspects will now be described in connection with exemplary embodiments, including certain aspects described in terms of sequences of actions that can be performed by elements of a computing device or system. For example, it will be recognized that in each of the embodiments, at least some of the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described.

According to an exemplary embodiment, a synchronous activity, i.e., an activity where two or more principals are simultaneously available, can be arranged by assistant components associated with each of the principals. In one embodiment, when a first principal wishes to engage in a synchronous activity, e.g., a phone call, with a second principal, the respective assistant components can interact with one another to determine a time to suggest to the first principal as an appropriate time to engage in the activity.

In one embodiment, the first principal can instruct its associated assistant component, referred to here as a first assistant, to send a tag request to the assistant component associated with the second principal, referred to here as a second assistant. The tag request asks the second assistant to inform the first principal when the second principal is available to engage in the activity. When the second assistant determines that the second principal is available to engage in the activity with the first principal, the second assistant can notify the first assistant, and if the first principal is available at that time, the first assistant can notify the first principal that the second principal is ready.

Advantageously, the second principal is not disturbed any more than with any other phone call—in fact, less so, because fewer attempts to call are made and fewer messages are deposited in the voice mailbox. The first principal can receive a mild suggestion from the first assistant to call the second principal, and can ignore the suggestion when the first principal is otherwise occupied. In any event, the first principal can avoid wasting time by repeatedly attempting to call the second principal unsuccessfully, thereby improving productivity and reducing frustration. While the disclosed approach will be conveniently described in terms of a phone call, it can be equally applicable for other types of synchronous activities, including activities not involving a traditional telecommunication network.

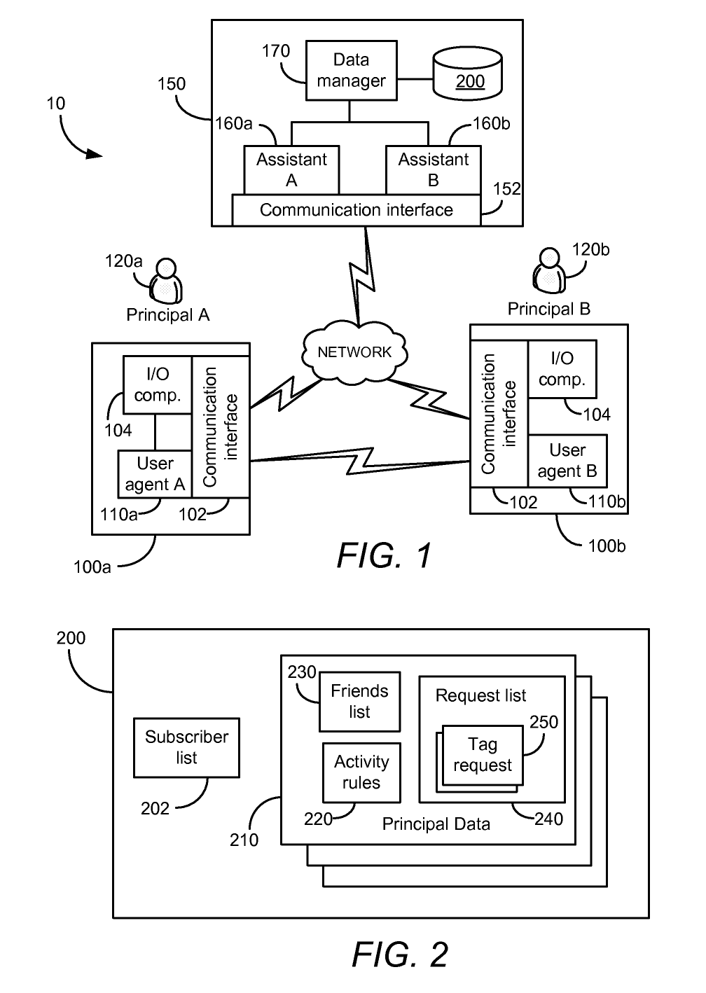

FIG. 1 is an exemplary block diagram showing a system for coordinating a synchronous activity according to one embodiment. The system 10 includes a plurality of communication devices 100a, 100b communicatively coupled to a server 150 via a network 130, such as the Internet, so that information can be exchanged between the devices 100a and the server 150 “in-band.” In one embodiment, the plurality of communication devices 100a, 100b are also communicatively coupled to each other via a channel other than the network 130 so that information can be transmitted between devices 100a, 100b “out-of-band.” Each device 100a, 100b is associated with a principal 120a, 120b, which can be a human user.

According to one embodiment, the communication device, e.g., 100a, can be a laptop or desktop computer, a digital camera/phone, a PDA, a smart phone, and the like. The device 100a includes circuitry for communicating with the server 150 and with other devices 100b. For example, the device 100a can include a communication interface 102 coupled to an input/output component 104 that allows the principal 120a to use the device 100a to communicate with the server 150 over a wired or wireless network 130 or with other devices 100b over the channel using one or more communication protocols.

In an exemplary embodiment, the communication device 100a includes a means for monitoring the activities of the principal 120a. For example, the communication device 100a can include a user agent component 110a that is configured to monitor the first principal's 120a availability to receive information and/or to participate in synchronous activities. In an exemplary embodiment, the user agent component 110a serves as a proxy for the principal 120a, where the agent component 110a captures the assumption that the principal 120a may not always be available, either because of lack of network connectivity or battery power, or because the principal 120a wishes to remain off-line. In one embodiment, the user agent component 110a can be coupled to the input/output component 104 to determine the principal's 120a availability, and coupled to the communication interface 102 so that the agent component's determinations can be sent to the server 150.

According to an exemplary embodiment, the server 150 can be a personal computer or some other device capable of processing and storing data. The server 150 also includes a communication interface 152 to transmit and receive data securely over the network 130. In an exemplary embodiment, the server 150 includes means for receiving an instruction from a principal, e.g., 120a, to send a tag request to another principal, e.g., 120b, to participate in a synchronous activity, and for sending the tag request to the other principal 120b. The server 150 also includes means for determining whether a principal 120a, 120b is available to participate in an activity related to a tag request, means for receiving a response indicating that another principal 120b is available to participate in an activity, and means for notifying the principal 120a that the other principal 120b is available to participate in the activity.

For example, in an exemplary embodiment, the server 150 can include a plurality of assistant components 160a, 160b, each of which is associated with a principal 120a, 120b. Each assistant component, e.g., 160a, is configured to interact with other assistant components, e.g., 160b, to arrange synchronous interactions between the associated principals 120a, 120b. In one embodiment, each assistant component, e.g., 160a, can process and send a tag request to another principal 120b on behalf of its principal 120a, and can receive and process a tag request from another principal 120b.

In one embodiment, each assistant component, e.g., 160a, can be configured to receive a tag request from the associated principal 120a and to send the tag request to a second principal 120b via the assistant component 160b associated with the second principal 120b. Each assistant component, e.g., 160b, can be further configured to receive the tag request and to determine whether the associated principal 120b is available to participate in the activity related to the tag request. In one embodiment, each assistant component, e.g., 160b, can utilize the user agent component 110b corresponding to the associated principal 120b to determine the principal's 120b availability. When the second principal 120b is available to participate in the activity, each assistant component, e.g., 160b, can be configured to send and receive a response that indicates that the second principal 120b is available and to notify the associated principal 120a of the second principal's availability via the communication interface 152.

According to an exemplary embodiment, each assistant component 160a, 160b is configured to process tag requests based on the associated principal's 120a, 120b preferences, which are expressed in terms of a variety of context elements, including, but not limited to, location, call logs, calendar entries, ringer tone, speaker volume, and other settings. Accordingly, the server 150 includes a data store 200 for storing information related to the principals' 120a, 120b preferences. Each assistant component 160a, 160b can be configured to add, remove, and retrieve information related to its associated principal 120a, 120b using a data manager 170.

FIG. 2 is a block diagram illustrating types of data that can be stored in the data store 200 according to one embodiment. The data store 200 can include a subscriber list 202 that identifies the principals 120a, 120b who are allowed to send and receive tag requests, and principal data 210 associated with the subscribed principals 120a, 120b. In one embodiment, the principal data 210 associated with a principal e.g., 120a, can include a friends list 230, activity rules 220 and a request list 240. The friends list 230 identifies other principals 120b from whom the principal 120a is willing to accept tag requests. In one embodiment, the friends list 230 can include information relating to each entry, such as the entry's authentication information, IP address, and phone number. A principal (friend) on the friends list 230 can be associated with an importance factor that indicates the relative importance of the friend to the principal 120a. For example, the importance factor associated with the principal's mother can be greater than the importance factor associated with the principal's co-worker.

The activity rules 220 can identify the circumstances under which the principal 120a is willing to participate in an activity. In one embodiment, the activity rules 220 can indicate a time period during which the principal 120a can or cannot participate in the activity. The activity rules 220 can also indicate one or more locations where the principal 120a will or will not participate in the activity. For example, the activity rules 220 for a phone call can indicate that the principal 120a cannot accept phone calls between the hours of 6:00 p.m. in the evening and 8:00 a.m. in the morning, and will not accept phone calls at “home” and/or at “the vacation house.”

The request list 240 includes one or more tag requests 250 that are pending for the principal 120a. In one embodiment, when the principal 120a is not available to participate in an activity relating to a tag request 250, the tag request 250 can be placed in the request list 240 so that when the principal 120a does become available, the tag request 250 can be processed. In one embodiment, the request list 240 includes a plurality of tag requests 250 that are ordered according to their respective priorities. Thus, when the principal 120a becomes available, the tag requests 250 can be processed in order by priority, from highest to lowest.

The system 10 illustrated in FIG. 1 and FIG. 2 is but one exemplary arrangement. In this configuration, the device 100a, 100b can be a “thin” mobile communication device because the principal data 210 can be stored remotely and the functionality of the assistant components 160a, 160b can be included in a separate server 150. Other arrangements can be designed by those skilled in the art. For example, the assistant components 160a, 160b can be included in the same server 150, as shown in FIG. 1 or in separate servers. In addition, the user agent components 110a, 110b can be included in the respective communication devices 100a, 100b, as shown, or in the server 150. Variations of these embodiments may be utilized and structural and functional modifications may be made without departing from the scope of the present disclosure.

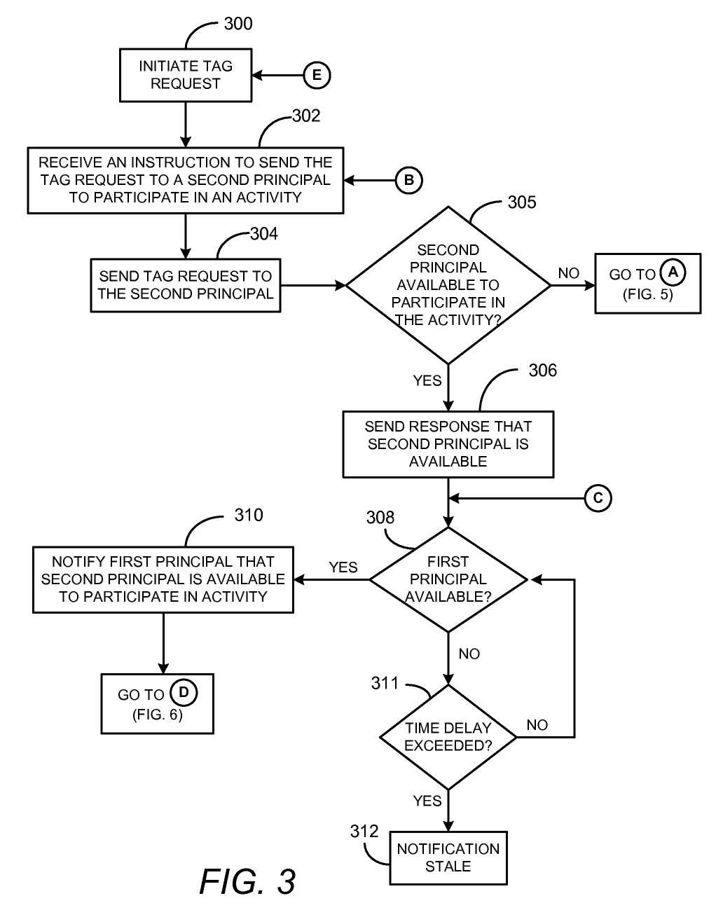

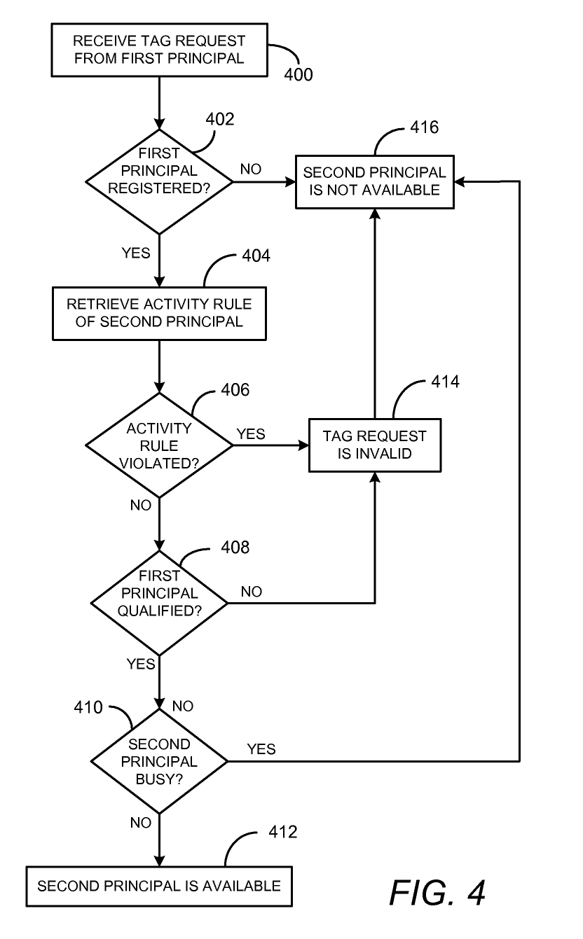

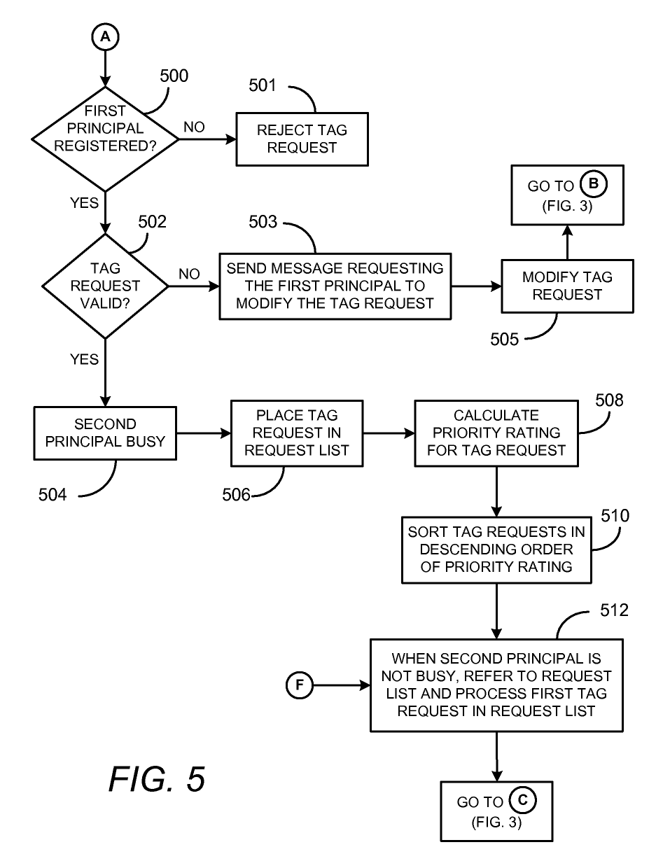

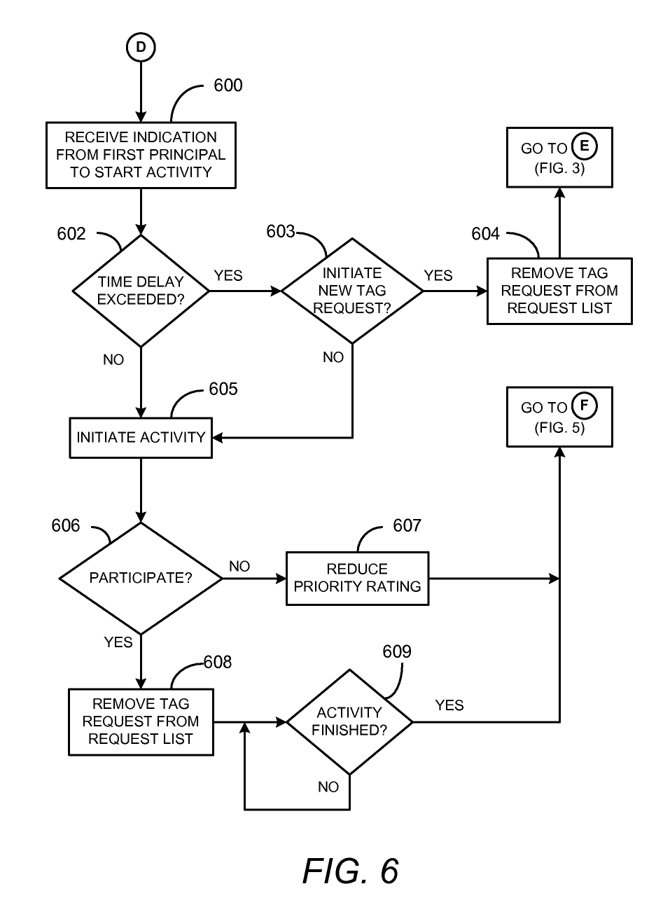

An exemplary process for coordinating a synchronous activity between first and second principals is provided in the flow diagrams of FIG. 3, FIG. 4, FIG. 5 and FIG. 6. In this exemplary process, the synchronous activity is a phone call although it can be any interaction that requires both principals to be simultaneously available. Referring to FIG. 1, FIG. 2 and FIG. 3, the process begins when the first principal 120a initiates a tag request 250 (block 300). In one embodiment, the first principal 120a can initiate the tag request 250 after the first principal 120a has made an unsuccessful attempt to call the second principal 120b, or absent such an attempt. In an exemplary embodiment, either the first assistant component 160a or the first user agent component 110a can be configured to generate the tag request 250 by prompting the first principal 120a to provide one or more request parameters relating to the tag request 250. For example, the request parameters can include at least one of an identifier of the second principal 120b, a time frame in which the activity is to be performed, a location of the first principal 120a and/or the second principal 120b for the activity, an urgency indicator, and a tag request expiration time.

According to one embodiment, the first principal 120a can elect to generate a quick tag or a careful tag depending on the circumstances and on the nature of the activity. In one embodiment, a quick tag requires the principal 120a to provide minimal request parameters, while a careful tag requires the principal 120a to specify values for each request parameter. A quick tag can be appropriate when the first principal 120a needs to have a short conversation with the second principal 120b and when the first principal 120a receives a busy signal during the attempted phone call. Because minimal request parameters are required, a quick tag can be generated with less effort by the first principal 120a and therefore can be sent to the second principal 120b faster. This may be important because there is a presumption that the second principal 120b might be available to talk immediately after the present phone call ends. In one embodiment, the first principal 120a can generate a quick tag by simply providing the identifier of the second principal 120b. The values for the other request parameters can be automatically provided with default values, such as “ASAP” for the time frame, “anywhere” for the location(s), “medium” for urgency, and “one day” for the tag request expiration time. The default values can be predefined or set by the first principal 120a.

In contrast, a careful tag can be appropriate when the initial call was not answered because the second principal 120b may have been busy or because the second device 100b may have been off-line. In either case, it is less likely that the second principal 120b will be available within a short while. Alternatively, the first principal may not expect to be available within a short while, e.g., he is calling from a airplane about to take off and would have to disable the communication function of his communication device for several hours. For this reason, the careful tag can capture any special constraints that the first principal 120a may have. In one embodiment, the first principal 120a can generate a careful tag by providing the identifier of the second principal 120b and specific values for each of the request parameters. For example, the first principal 120a can specify that time frame for the activity be “within one hour,” that the location be “at work,” that the urgency is “high,” and that the tag request will expire in “one hour.”

Referring again to FIG. 3, once the tag request 250 is initiated and generated, the first assistant component 160a receives an instruction from the first principal 120a to send the tag request 250 to the second principal 120b to participate in the activity (block 302) via the communication interfaces 102, 152. In one embodiment, the first assistant component 160a can be configured to determine whether the second principal 120b is allowed to receive tag requests 250, i.e., whether the second principal 120b is subscribed to the tag request service. The first assistant component 160a can use the data manager 170 to retrieve an entry from the subscriber list 202 that matches the second principal 120a. If the second principal 120a is not on the subscriber list 202, the first assistant component 160a can reject the tag request 250 and notify the first principal 120a that the second principal 120b is not allowed to receive tag requests 250.

If the second principal 120b is a subscriber, the first assistant component 160a can send the tag request 250 to the second principal (block 304) via the second assistant component 160b. In one embodiment, the second assistant component 160b can be located in the server 150 (as shown in FIG. 1) or elsewhere in another server.

Once the tag request 250 is received, the second assistant component 160b can determine whether the second principal 120b is available to participate in the activity (block 305). FIG. 4 is a flow diagram illustrating an exemplary process for determining whether the second principal 120b is available to participate in the activity according to an exemplary embodiment. In one embodiment, after the second assistant component 160b receives the tag request 250 (block 400), it determines whether the first principal 120a is registered to submit the tag request 250 to the second principal 120b (block 402). In one embodiment, the second assistant component 160b can retrieve the friends list 230 of the second principal 120b from the data store 200 via the data manager 170 to determine whether the first principal 120a is on the friends list 230.

When the first principal 120a is registered (block 402), the second assistant component 160b can now determine whether the tag request 250 is valid. In one embodiment, the second assistant component 160b can retrieve the activity rules 220 of the second principal 120b from the data store 200 (block 404) and then determine whether any of the request parameters in the tag request 250 violate any of the activity rules 220. For example, if an activity rule 220 indicates that the second principal 120b will not take calls at home, and the tag request 250 includes a request parameter that indicates that the first principal 120a would like to call the second principal 120b at home, the request parameter violates the activity rule 220.

In another embodiment, the activity rules 220 can also be specific to particular principals and the second assistant component 160b can determine whether the first principal 120a is qualified for each of the request parameters in the tag request 250 (block 408). For example, an activity rule 220 can indicate that the second principal 120b will take calls at home unless the caller is the first principal 120a. In this circumstance, although the request parameter itself does not violate the activity rule 220, the first principal 120a is not qualified. When the second assistant component 160b determines that an activity rule 220 is violated (block 406) and/or that the first principal 120a is not qualified (block 408), the tag request 250 is deemed invalid (block 414).

When an activity rule 220 has not been violated and the first principal 120a is qualified, the second assistant component 160b continues by determining whether the second principal 120b is busy (block 410). In one embodiment, the second assistant component 160b can invoke the second user agent component 110b to determine whether the second principal 120b is on a phone call, off-line, or otherwise preoccupied. When the second principal 120b is not busy, the second principal 120b is deemed available to participate in the activity (block 412). In contrast, when the second principal 120b is busy (block 410), or when the tag request 250 is invalid (block 414), or when the first principal 120a is not registered (block 402), the second principal 120b is not available to participate in the activity 416.

Referring again to FIG. 3, when the second principal 120b is available (block 305), the second assistant component 160b can send a response indicating the second principal 120b is available to participate in the activity (block 306). When the second principal 120b is not available (block 305), the process continues to circle “A” in FIG. 5. Referring to FIG. 5, when the second principal 120b is not available because the first principal 120a is not registered (block 500), the second assistant component 160b rejects the tag request 250 (block 501). In one embodiment, the second assistant component 160b can inform the first assistant component 160b of the rejection, which in turn can inform the first principal 120a. In addition, the second assistant component 160b can store the rejected tag request 250 in the data store 200 in a rejected tag folder so that the second principal 120b can view it if he wishes.

When the first principal 120a is registered but the second principal 120b is not available because the tag request is invalid (block 502), the second assistant component 160b can send a message to the first assistant component 160b requesting the first principal 120a to modify the tag request 250 (block 505). In one embodiment, the message can indicate which request parameters need to be modified to make the tag request 250 valid. The message can be sent from the first assistant component 160b to the first principal 120a via the network 130. Once the first principal 120a receives the message and modifies the tag request (block 505), process blocks 302 through 305 (FIG. 3) are repeated.

When the first principal 120a is registered (block 500) and the tag request is valid (block 502), but the second principal 120b is not available because the second principal 120b is busy (block 504), the tag request 250 is placed in the request list 240 of the second principal 120b (block 506). In one embodiment, the request list 240 can include a plurality of tag requests 250 that are pending for the second principal 120b. In this embodiment, the second assistant component 160b can calculate a priority rating for each tag request 250 based on at least one of the request parameters, the importance factor of the first principal 120a, and the second principal's preferences. Once the priority ratings are calculated, the tag requests 250 can be sorted in descending order according to their respective priority ratings (block 510).

In an exemplary embodiment, when the second principal 120b is eventually determined not to be busy, the second assistant component 160b refers to the request list 240 and processes the first tag request 250 on the list 240 (block 512). In one embodiment, the second assistant component 160b can process the tag request 250 by analyzing the tag request 250 to determine whether each of the request parameters is satisfied. For example, the second assistant component 160b can check each request parameter value, e.g., the expiration time, to ensure that the present conditions, e.g., time of day, satisfy the request parameter values. When such is the case, the second assistant component 160b can send the response indicating the second principal 120b is available to participate in the activity associated with the tag request 250.

In another embodiment, if the tag request 250 is urgent and the first principal 120a is of high importance, i.e., the associated importance factor is high, the second assistant component 160b can process the tag request 250 even when the second principal 120b appears to be busy. Accordingly, in this embodiment, the second principal 120b can choose to interrupt an ongoing call to take an urgent call from a high priority caller, such as his or her mother.

Once the tag request 250 is processed, the method continues at circle “C” in FIG. 3. Referring again to FIG. 3, when the second principal 120b is available (block 305) and the second assistant component 160b sends the response indicating the second principal 120b is available to participate in the activity (block 306), or when the second principal 120b is no longer busy and the tag request 250 is processed (block 512 of FIG. 5), the first assistant component 160b can receive the response from the second assistant component 160b and determine whether the first principal 120a is available to receive a notification from the first assistant component 160b (block 308). In an exemplary embodiment, the first assistant component 160b can invoke the first user agent component 110a to determine whether the first principal 120a is available to receive the notification. The notification can indicate that “now is a good time to call” the second principal 120b.

When the first principal 120a is not available, the first assistant component 160b can hold the notification and periodically invoke the first user agent component 110a to determine whether the first principal 120a is available. In one embodiment, the first assistant component 160b can wait for the first principal 120a to become available for a time period not exceeding a first predetermined time delay, e.g., five (5) minutes. According to one embodiment, the time period is measured from the time the response was received to the time the notification is delivered. When the time period exceeds the time delay (block 311) and the first principal 120a is still unavailable, the notification becomes stale (block 312). In one embodiment, the first assistant component 160b can delete the notification, and when the first principal 120a is available, inform the first principal 120a that the notification was received, but became stale.

When the first principal 120a is or becomes available within the first predetermined time delay (block 308), the first assistant component 160b notifies the first principal 120a that the second principal 120b is available to participate in the activity (block 310), e.g., “now would be a good time to call.” In one embodiment, the first assistant component 160b can send the notification to the first principal's communication device 100a and the notification can be displayed to the first principal 120a via the input/output component 104. In another embodiment, when the communication device 100a receives the notification, it can provide an alarm, such as a ring tone or vibration.

Once the first principal 120a receives the notification, the first principal 120a can elect to start the activity with the second principal 120b, e.g., initiate a phone call to the second principal 120b. In one embodiment, the phone call can be an “out-of-band” communication, and if the call is again unsuccessful, the first principal 120a can be prompted to generate another tag request 250. In another embodiment, the first principal 120a can utilize the first assistant component 160b to facilitate the activity. In this embodiment, the process proceeds to circle “D” in FIG. 6.

Referring now to FIG. 6, in one embodiment, the second assistant component 160b can receive an indication from the first principal 120a (via the first assistant component 160a) to start the activity with the second principal 120b (block 600). For example, the indication from the first principal 120a can instruct the second assistant component 160b to initiate a phone call to the second principal 120b. According to an exemplary embodiment, before initiating the activity, the second assistant component 160b can determine whether a time period measured from the time the response was sent (block 306 in FIG. 3) to the time the indication was received exceeds a second predetermined time delay (block 602). In one embodiment, the second predetermined time delay can be the same as the first predetermined time delay used to determine whether the notification is stale (block 311 in FIG. 3). Alternatively, the second predetermined time delay can be a value set by the second principal 120b.

When the second predetermined time delay has been exceeded, the likelihood that the second principal 120b is still available is low. Accordingly, in one embodiment, the second assistant component 160b can inform the first assistant component 160a that the second principal 120b may no longer be available, and the first assistant component 160a can ask the first principal 120a whether a new tag request 250 should be initiated 250 (block 603). When the first principal 120a elects to initiate a new tag request 250, the second assistant component 160b can remove the first tag request 250 from the request list 240 (block 604), and the first principal 120a can initiate the new tag request 250 (block 300 in FIG. 3). If, however, the first principal 120a elects not to initiate a new tag request 250 (block 603), the second assistant component 160b can initiate the activity with the second principal 120b (block 605). If the second principal 120b cannot or will not participate (block 606), the second assistant component 160b can reduce the priority rating of the tag request 250 (block 607) and process the next tag request 250 on the request list 240 when the second principal 120b is not busy (block 512 in FIG. 5).

In an exemplary embodiment, when the second predetermined time delay has not been exceeded, the second assistant component 160b initiates the activity with the second principal 120b (block 605). When the second principal 120b participates in the activity (block 606), the second assistant component 160b can remove the tag request 250 from the request list 240 (block 608). In one embodiment, in addition to removing the tag request 250 from the request list 240, the second assistant component 160b can increase the importance factor associated with the first principal 120a based on the second principal's 160b decision to participate in the activity. When the activity is finished (block 609), the second assistant component 160b can process the next tag request 250 on the request list 240 when the second principal 120b is not busy (block 512 in FIG. 5). Alternatively, when the second principal 120b cannot or will not participate (block 606), the second assistant component 160b can reduce the priority rating of the tag request 250 (block 607) and process the next tag request 250 on the request list 240 when the second principal 120b is not busy (block 512 in FIG. 5).

The executable instructions of a computer program as illustrated in FIGS. 3-6 can be embodied in any computer readable medium for use by or in connection with an instruction execution system, apparatus, or device, such as a computer based system, processor containing system, or other system that can fetch the instructions from the instruction execution system, apparatus, or device and execute the instructions.

As used here, a “computer readable medium” can be any means that can contain, store, communicate, propagate, or transport the program for use by or in connection with the instruction execution system, apparatus, or device. The computer readable medium can be, for example, but is not limited to, an electronic, magnetic, optical, electromagnetic, infrared, or semiconductor system, apparatus, device, or propagation medium.

More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), or (g) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A method for coordinating a synchronous activity, the method comprising:
receiving an instruction from a first principal to send a tag request to a second principal to participate in an activity, wherein at least one of the first and second principals is a human;
sending the tag request to the second principal;
determining whether the second principal is available to participate in the activity after the tag request is received;
sending a response indicating the second principal is available to participate in the activity; and
notifying the first principal that the second principal is available to participate in the activity after receiving the response and determining that the first principal is available to receive the notification.

2. The method of claim 1 further comprising generating the tag request by prompting the first principal to provide at least one request parameter that includes at least one of an identifier of the second principal, a time frame in which the activity is to be performed, a location of at least one of the first principal and the second principal for the activity, an urgency indicator, and a tag request expiration time.

3. The method of claim 2 wherein determining whether the second principal is available to participate in the activity comprises:
determining whether the first principal is registered to submit the tag request to the second principal and rejecting the tag request when the first principal is not registered; and
determining whether the tag request is valid when the first principal is registered.

4. The method of claim 3 wherein determining whether the tag request is valid includes:
retrieving an activity rule designated by the second principal, wherein the activity rule defines circumstances under which the second principal will participate in the activity;
determining whether any of the at least one request parameters in the tag request violate the activity rule; and
concluding the tag request is valid when the at least one request parameters comply with the activity rule.

5. The method of claim 4 wherein determining whether the tag request is valid further includes:
determining whether the first principal is qualified for each of the at least one request parameters based on the activity rule; and
concluding the tag request is valid when the first principal is qualified.

6. The method of claim 3 further comprising:
sending a message requesting the first principal to modify and resend the tag request when the tag request is invalid.

7. The method of claim 2 further comprising processing the tag request when the second principal is determined to be available to participate in the activity by:
analyzing the tag request to determine whether each of the at least one request parameters is satisfied; and
sending the response indicating the second principal is available to participate in the activity when each of the at least one request parameters is satisfied.

8. The method of claim 2 wherein the activity is a phone conversation and the method further comprises:
attempting a phone call from the first principal to the second principal; and
determining whether the first principal wants to generate the tag request when the attempted phone call is unsuccessful.

9. The method of claim 1 further comprising placing the tag request in a request list for the second principal when the second principal is not available to participate in the activity.

10. The method of claim 9 further comprising referring to the request list when the second principal is available to participate in the activity and processing the tag request in the request list.

11. The method of claim 9 wherein the request list comprises a plurality of tag requests and the method further comprises:
calculating a priority rating for the tag request based on the at least one request parameters; and
sorting the plurality of tag requests in descending order according to their respective priority ratings.

12. The method of claim 11 wherein the activity is a phone conversation and the method further comprises:
initiating by the first principal a phone call to the second principal when the first principal receives the notification that the second principal is available to participate in a phone conversation; and
modifying the priority rating of the tag request based on whether the second principal agrees to participate in the phone conversation.

13. The method of claim 1 further comprising:
receiving an indication from the first principal to start the activity after the notification is received;
determining whether a time period between receiving the indication and sending the response is greater than a predetermined time delay;
determining whether the first principal wants to generate another tag request when the time period exceeds the predetermined time delay; and
initiating the activity when the time period is within the predetermined time delay.

14. A computer readable medium containing program instructions for coordinating a synchronous activity, the computer readable medium comprising program instructions for:
receiving an instruction from a first principal to send a tag request to a second principal to participate in an activity, wherein at least one of the first and second principals is a human;
sending the tag request to the second principal;
determining whether the second principal is available to participate in the activity after the tag request is received;
sending a response indicating the second principal is available to participate in the activity; and
notifying the first principal that the second principal is available to participate in the activity after receiving the response and determining that the first principal is available to receive the notification.

15. The computer readable medium of claim 13 further comprising generating the tag request by prompting the first principal to provide at least one request parameter that includes at least one of an identifier of the second principal, a time frame in which the activity is to be performed, a location of at least one of the first principal and the second principal for the activity, an urgency indicator, and a tag request expiration time.

16. The computer readable medium of claim 14 wherein the instructions for determining whether the second principal is available to participate in the activity further comprise instructions for:
determining whether the first principal is registered to submit the tag request to the second principal and rejecting the tag request when the first principal is not registered; and
determining whether the tag request is valid when the first principal is registered.

17. The computer readable medium of claim 15 wherein the instructions for determining whether the tag request is valid include:
retrieving an activity rule designated by the second principal, wherein the activity rule defines circumstances under which the second principal will participate in the activity;
determining whether any of the at least one request parameters in the tag request violate the activity rule; and
concluding the tag request is valid when the at least one request parameters comply with the activity rule.

18. The computer readable medium of claim 16 wherein the instructions for determining whether the tag request is valid further include:
determining whether the first principal is qualified for each of the at least one request parameters based on the activity rule; and
concluding the tag request is valid when the first principal is qualified.

19. The computer readable medium of claim 15 further comprising instructions for:
sending a message requesting the first principal to modify and resend the tag request when the tag request is invalid.

20. The computer readable medium of claim 15 further comprising instructions for processing the tag request when the second principal is determined to be available to participate in the activity, the processing instructions including instructions for:
analyzing the tag request to determine whether each of the at least one request parameters is satisfied; and
sending the response indicating the second principal is available to participate in the activity when each of the at least one request parameters is satisfied.

21. The computer readable medium of claim 15 wherein the activity is a phone conversation and the computer readable medium further comprises instructions for:
attempting a phone call from the first principal to the second principal; and
determining whether the first principal wants to generate the tag request when the attempted phone call is unsuccessful.

22. The computer readable medium of claim 14 further comprising instructions for placing the tag request in a request list for the second principal when the second principal is not available to participate in the activity.

23. The computer readable medium of claim 22 further comprising instructions for referring to the request list when the second principal is available to participate in the activity and processing the tag request in the request list.

24. The computer readable medium of claim 22 wherein the request list comprises a plurality of tag requests and the computer readable medium further comprises instructions for:
calculating a priority rating for the tag request based on the at least one request parameters; and
sorting the plurality of tag requests in descending order according to their respective priority ratings.

25. The computer readable medium of claim 24 wherein the activity is a phone conversation and the computer readable medium further comprises instructions for:
initiating by the first principal a phone call to the second principal when the first principal receives the notification that the second principal is available to participate in a phone conversation; and
modifying the priority rating of the tag request based on whether the second principal agrees to participate in the phone conversation.

26. The computer readable medium of claim 14 further comprising instructions for:
receiving an indication from the first principal to start the activity after the notification is received;
determining whether a time period between receiving the indication and sending the response is greater than a predetermined time delay;
determining whether the first principal wants to generate another tag request when the time period exceeds the predetermined time delay; and
initiating the activity when the time period is within the predetermined time delay.

27. A system for coordinating a synchronous activity comprising:
means for receiving an instruction from a first principal to send a tag request to a second principal to participate in an activity, wherein at least one of the first and second principals is a human;
means for sending the tag request to the second principal;
means for determining whether the second principal is available to participate in the activity after the tag request is received;
means for sending a response indicating the second principal is available to participate in the activity; and
means for notifying the first principal that the second principal is available to participate in the activity after receiving the response and determining the first principal is available to receive the notification.

28. A system for coordinating a synchronous activity, the system communicatively coupled via a network to first and second communication devices associated with respective first and second principals, wherein at least one of the first and second principals is a human, the system comprising:
a first assistant component associated with the first principal for receiving an instruction from the first communication device to send a tag request to the second principal to participate in an activity; and
a second assistant component associated with the second principal configured to receive the tag request from the first assistant component, to determine whether the second principal is available to participate in the activity via the second communication device, and to send a response to the first assistant component when the second assistant component determines that the second principal is available to participate in the activity; wherein
the first assistant component is further configured to notify the first principal that the second principal is available to participate in the activity after the first assistant component receives the response from the second assistant component and determines that the first principal is available to receive the notification via the first communication device.

29. The system of claim 28 further comprising:
a first agent component associated with the first principal; and
a second agent component associated with the second principal;
wherein each of the first and second agent components are configured to monitor the respective first and second principal's availability to receive notifications and to participate in an activity using the first and second communication devices respectively.

30. The system of claim 29 wherein the first and second communication devices include the first and second agent components, respectively.

31. The system of claim 29 wherein one of the first agent component and the first assistant component is configured to generate a tag request by prompting the first principal to provide at least one request parameter that includes at least one of an identifier of the second principal, a time frame in which the activity is to be performed, a location of at least one of the first principal and the second principal for the activity, an urgency indicator, and a tag request expiration time.

32. The system of claim 31 wherein before determining whether the second principal is available to participate in the activity the second assistant component is further configured to determine whether the first principal is registered to submit the tag request to the second principal and to reject the tag request when the first principal is not registered, and to determine whether the tag request is valid when the first principal is registered.

33. The system of claim 32 wherein the second assistant component is configured to determine whether the tag request is valid by retrieving an activity rule designated by the second principal, wherein the activity rule defines circumstances under which the second principal will participate in the activity, determining whether any of the at least one request parameters in the tag request violate the activity rule, and concluding the tag request is valid when the at least one request parameters comply with the activity rule.

34. The system of claim 33 wherein the second assistant component is configured to determine whether the tag request is valid by determining whether the first principal is qualified for each of the at least one request parameters based on the activity rule, and concluding the tag request is valid when the first principal is qualified.

35. The system of claim 32 wherein the second assistant component is configured to send a message to the first assistant component requesting the first principal to modify and resend the tag request when the tag request is invalid.

36. The system of claim 31 wherein when the second assistant component determines that the second principal is available to participate in the activity, the second assistant component is further configured to process the tag request by analyzing the tag request to determine whether each of the at least one request parameters is satisfied, and sending the response to the first assistant component indicating the second principal is available to participate in the activity when each of the at least one request parameters is satisfied.

37. The system of claim 31 wherein the first and second communication devices are phones and the activity is a phone conversation, and wherein one of the first agent component and the first assistant component is configured to determine whether the first principal wants to generate a tag request when an attempted phone call to the second principal is unsuccessful.

38. The system of claim 28 wherein the second assistant component is further configured to place the tag request in a request list for the second principal when the second principal is not available to participate in the activity.

39. The system of claim 38 wherein the second assistant component is further configured to refer to the request list when the second principal is available to participate in the activity and to process the tag request in the request list.

40. The system of claim 38 wherein the request list comprises a plurality of tag requests and the second assistant component is further configured to calculate a priority rating for the tag request based on the at least one request parameters, and to sort the plurality of tag requests in descending order according to their respective priority ratings.

41. The system of claim 40 wherein the first and second communication devices are phones and the activity is a phone conversation, and wherein the second assistant component is further configured to modify the priority rating of the tag request based on whether the second principal agrees to participate in the phone conversation initiated by the first principal when the first principal receives the notification that the second principal is available to participate in a phone conversation.

42. The system of claim 28 wherein the second assistant component is configured to receive an indication from the first principal to start the activity after the notification is received, to determine whether a time period between receiving the indication and sending the response is greater than a predetermined time delay, to determine whether the first principal wants to generate another tag request when the time period exceeds the predetermined time delay, and to initiate the activity with the second principal when the time period is within the predetermined time delay.
